(19) United States
(12) Patent Application Publication
(10) Pub. No.: US 2026/0158939 A1
(43) Pub. Date: Jun. 11, 2026

(54) FUEL CELL VEHICLE AND A METHOD OF CONTROLLING THE SAME

(71) Applicants: HYUNDAI MOTOR COMPANY, Seoul (KR); KIA CORPORATION, Seoul (KR)

(72) Inventors: Joo Seung Lee, Hwaseong-si (KR); Woo Young Lee, Hwaseong-si (KR); Yoon Tae Kim, Hwaseong-si (KR); Hyeon Ju Jeong, Hwaseong-si (KR); Jae Ho Kim, Hwaseong-si (KR); Sae Kwon Chang, Hwaseong-si (KR); Jong Jun Lee, Hwaseong-si (KR)

(73) Assignees: HYUNDAI MOTOR COMPANY, Seoul (KR); KIA CORPORATION, Seoul (KR)

(21) Appl. No.: 19/190,342

(22) Filed: Apr. 25, 2025

(30) Foreign Application Priority Data
Dec. 10, 2024 (KR) 10-2024-0183034

(51) Int. Cl. B60L 50/75; B60L 58/30; H01M 8/0432; H01M 8/04537; H02M 1/00

(52) U.S. Cl. CPC B60L 50/75; B60L 58/30; H01M 8/0432; H01M 8/04649; H02M 1/0009; H02M 1/009

(57) ABSTRACT

A fuel cell vehicle includes a battery, a cell stack configured to supply a stack voltage, a multiphase converter configured to adjust a voltage range between the cell stack and the battery. The multiphase converter includes a plurality of current paths connected to the cell stack. The fuel cell vehicle further includes a main controller configured to, for measurement of impedance of the cell stack, control the multiphase converter to allow an alternating current to flow along an auxiliary path rather than a main path used to adjust the voltage range among the plurality of current paths.

### CROSS-REFERENCE TO RELATED APPLICATION

This application claims the benefit of and priority to Korean Patent Application No. 10-2024-0183034, filed on Dec. 10, 2024, the entire contents of which are hereby incorporated herein by reference.

### BACKGROUND

### Field of the Disclosure

The present disclosure relates to a fuel cell vehicle and a method of controlling the same.

### DISCUSSION OF THE RELATED ART

A fuel cell vehicle includes a fuel cell and a high-voltage boost DC/DC converter (or a fuel cell DC/DC converter (FDC)). The FDC is a converter that controls power output from the fuel cell. The fuel cell vehicle using the FDC has an advantage of boosting a low stack voltage to a high voltage, thereby reducing the number of cells of the fuel cell, which is the most expensive component of the fuel cell vehicle. In addition, because it is possible to satisfy the voltage specifications of a drive motor, an inverter, and a high-voltage battery, which have been developed for an electrified platform, the FDC may enable optimal design of the fuel cell vehicle regardless of the voltage specifications of electrified parts.

In addition, the FDC directly controls the output voltage or current of the fuel cell, and thus serves to protect the fuel cell through not only control of upper/lower voltage limits but also a function of limiting the output depending on conditions. Therefore, the durability and stability of the fuel cell may be improved through the FDC.

Because the FDC transmits high power/high current from the fuel cell stack to a load, the FDC should be driven with high efficiency. In addition, an FDC designed to withstand high current may be composed of multiple phases so as to distribute the current.

In the case in which the FDC is composed of multiple phases, the optimal number of phases to be driven among the multiple phases is determined in order to maximize efficiency depending on the amount of power passing through the FDC. This control method is usually called phase shedding.

If phase shedding is not applied, a fuel cell vehicle has relatively low efficiency in a light-load section. This is because, although the magnitude of power that is input is small, loss occurs in each phase, so the overall loss increases. On the other hand, if the number of phases to be driven is controlled in accordance with the magnitude of power, the FDC may be driven at an optimal operating point, thereby efficiently driving the fuel cell vehicle. Such phase shedding is applied to improve efficiency under light-load and heavy-load conditions in the multiphase structure.

Fuel cell/battery-related companies have recently been employing a technology called electrochemical impedance spectroscopy (EIS). EIS is a technology that measures the frequency impedance of a battery or a fuel cell, providing real-time information about the operation and performance of the fuel cell through measurement of the impedance. This allows the fuel cell to operate under optimal driving conditions, contributing to improved reliability and extended lifespan of the fuel cell. Particularly, because EIS enables prediction and avoidance of drying/flooding states, which must be completely avoided during operation of the fuel cell, EIS is a useful technology for improving durability. However, in order to utilize EIS technology, an alternating current (AC) waveform must be applied to the fuel cell side.

### SUMMARY

Embodiments of the present disclosure are directed to a fuel cell vehicle and a method of controlling the same that substantially obviate one or more problems due to limitations and disadvantages of the related art.

Embodiments of the present disclosure provide a fuel cell vehicle capable of implementing electrochemical impedance spectroscopy (EIS) at low cost and a method of controlling the same.

However, the objects to be accomplished by the present disclosure are not limited to the above-mentioned objects. Other objects not mentioned herein should be more clearly understood by those having ordinary skill in the art from the following description.

Additional advantages, objects, and features of the present disclosure are set forth in part in the description which follows and in part should become more apparent to those having ordinary skill in the art upon examination of the following description or may be learned from practice of the present disclosure. The objectives and other advantages of the present disclosure may be realized and attained by the structure particularly pointed out in the written description and the appended drawings, as well as the appended claims and equivalents thereof.

According to an embodiment, a fuel cell vehicle is provided. The fuel cell vehicle includes a battery and a cell stack configured to supply a stack voltage. The fuel cell vehicle also includes a multiphase converter configured to adjust a voltage range between the cell stack and the battery. The multiphase converter includes a plurality of current paths connected to the cell stack. The fuel cell vehicle further includes a main controller configured to, for measurement of impedance of the cell stack, control the multiphase converter to allow an alternating current to flow along an auxiliary path rather than a main path used to adjust the voltage range among the plurality of current paths.

In an example, the main controller may be configured to control the multiphase converter so that a direct current flowing along the main path contains only a direct-current component and the alternating current flowing along the auxiliary path contains only an alternating-current component.

In an example, the plurality of current paths includes first-N^{th} current paths.

In an example, the fuel cell vehicle may further include a voltage sensor configured to sense a voltage input to the multiphase converter and first-N^{th} current sensors configured to sense currents flowing along the first-N^{th} current paths. The main controller may be configured to determine the number of main paths using results of sensing by the voltage sensor and the first-N^{th} current sensors.

In an example, the fuel cell vehicle may further include a temperature sensor configured to sense the temperature of the cell stack. The main controller may be configured to determine the number of main paths using a result of sensing by the temperature sensor.

In an example, the main controller may be configured to determine one of the plurality of current paths to be the auxiliary path in response to an impedance signal requesting measurement of the impedance of the cell stack.

In an example, the multiphase converter may include an input capacitor connected to an output terminal of the cell stack, first-N^{th} inductors connected in parallel to each other, each of which includes an end connected between the output terminal of the cell stack and the input capacitor, first-N^{th} diode switches, each of which is connected between another end of a corresponding one of the first-N^{th} inductors and the battery, first-N^{th} semiconductor switches connected between nodes, between the first-N^{th} inductors and the first to N^{th} diode switches, and a reference potential, and an output capacitor connected between the battery and the reference potential.

In an example, the main controller may be configured to control switching operations of the first-N^{th} diode switches and the first-N^{th} semiconductor switches using a direct-current command value, an alternating-current command value, and results of sensing by the first-N^{th} current sensors.

In an example, the main controller may include a current division unit configured to divide the direct-current command value by the number of main paths, first to K^{th} (1≤K<N) main converter controllers configured to switch first to K^{th} diode switches and first to K^{th} semiconductor switches connected to the main paths among the first to N^{th} diode switches and the first to N^{th} semiconductor switches using the divided direct-current command value and current values sensed from the main paths by some of the first to N^{th} current sensors, and an auxiliary converter controller configured to switch an auxiliary diode switch and an auxiliary semiconductor switch connected to the auxiliary path among the first to N^{th} diode switches and the first to N^{th} semiconductor switches using the alternating-current command value and a current value sensed from the auxiliary path by one of the first to N^{th} current sensors.

In an example, a k^{th} (1≤k≤K) main converter controller may include a first subtractor configured to subtract a value obtained by sensing a current flowing along a k^{th} path among the main paths from the divided direct-current command value, a first proportional integrator configured to proportionally integrate an output from the first subtractor and output a result of proportional integration, a first limiter configured to limit the level of an output from the first proportional integrator, a first comparator configured to compare an output from the first limiter with a first reference signal and output a result of comparison as a k^{th} main switching control signal, and a first retarder configured to retard the k^{th} main switching control signal and output a result of retardation as a k′^{th} main switching control signal. The k^{th} semiconductor switch may be switched in response to the k^{th} main switching control signal, and a k^{th} diode switch may be switched in response to the k′^{th} main switching control signal.

In an example, the auxiliary converter controller may include a second subtractor configured to subtract a value obtained by sensing a current flowing along the auxiliary path from the alternating-current command value, a second proportional integrator configured to proportionally integrate an output from the second subtractor and output a result of proportional integration, a second limiter configured to limit the level of an output from the second proportional integrator, a second comparator configured to compare an output from the second limiter with a second reference signal and output a result of comparison as a first auxiliary switching control signal, and a second retarder configured to retard the first auxiliary switching control signal and output a result of retardation as a second auxiliary switching control signal. The auxiliary semiconductor switch may be switched in response to the first auxiliary switching control signal, and the auxiliary diode switch may be switched in response to the second auxiliary switching control signal.

In an example, the current division unit is configured to equally divide the direct-current command value by the number of main paths.

In an example, current paths among the plurality of current paths of the multiphase converter are connected in parallel to each other.

According to another embodiment, a method of controlling a fuel cell vehicle is provided. The fuel cell vehicle includes a battery, a cell stack configured to supply a stack voltage, and a multiphase converter configured to adjust a voltage range between the cell stack and the battery. The multiphase converter includes a plurality of current paths connected to the cell stack. The method includes acquiring information for selecting a main path used to adjust the voltage range from among the first to N^{th} current paths. The method also includes determining the main path among the plurality of current paths using the acquired information. The method additionally includes allowing a current containing only an alternating-current component to flow along an auxiliary path rather than the main path among the plurality of current paths and allowing a current containing only a direct-current component to flow along the main path, for measurement of impedance of the cell stack.

In an example, the information necessary to select the main path may include at least one of a voltage input to the multiphase converter, the value of a current flowing along each of the first to N^{th} current paths, or the temperature of the cell stack

In an example, current paths among the plurality of current paths of the multiphase converter are connected in parallel to each other.

It should be understood that both the foregoing general description and the following detailed description of the present disclosure are illustrative and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a fuel cell vehicle according to an embodiment;

FIG. 2 is a flowchart for explaining a method of controlling the fuel cell vehicle according to an embodiment;

FIG. 3 is a circuit diagram of an embodiment of the fuel cell vehicle shown in FIG. 1;

FIG. 4 is a block diagram of an embodiment of a main controller shown in FIG. 1;

FIG. 5 is a block diagram of an embodiment of first to K^{th} main converter controllers shown in FIG. 4;

FIG. 6 is a block diagram of an embodiment of an auxiliary converter controller shown in FIG. 4; and

FIGS. 7A-7H are waveform diagrams of respective terminals in circuits shown in FIGS. 3, 5, and 6.

### DETAILED DESCRIPTION

Embodiments of the present disclosure are described more fully hereinafter with reference to the accompanying drawings, in which various embodiments are shown. The present disclosure, however, may be embodied in many different forms, and should not be construed as being limited to the embodiments set forth herein. Rather, these embodiments are provided to make the present disclosure thorough and complete, and to fully convey the scope of the present disclosure to those having ordinary skill in the art.

It should be understood that when an element is referred to as being “on” or “under” another element, the element may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, and the like may separately embody or be included with a processor and a memory, such as a non-transitory computer readable media, as part of the apparatus.

Hereinafter, a fuel cell vehicle according to embodiments is described in more detail with reference to the accompanying drawings.

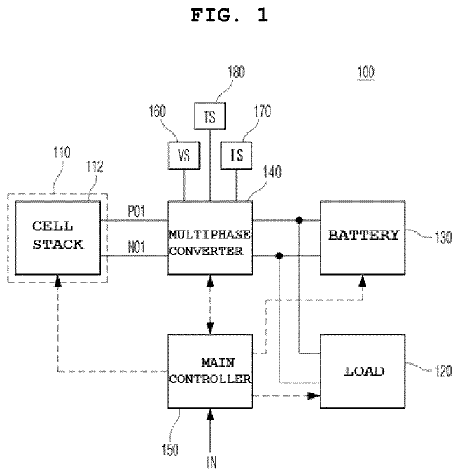

FIG. 1 is a block diagram of a fuel cell vehicle 100 according to an embodiment. The fuel cell vehicle 100 may include a fuel cell 110, a load 120, a battery (or a high-voltage battery) 130, a multiphase converter (a multiphase voltage level converter or a multiphase boost converter) 140, and a main controller 150. In FIG. 1, solid lines represent paths along which power is supplied, and dotted lines represent paths along which control signals are transmitted. In addition, the fuel cell vehicle 100 may further include at least one of a voltage sensor (VS) 160, a current sensor (IS) 170, or a temperature sensor (TS) 180.

The fuel cell 110 may include a plurality of unit fuel cells. The plurality of unit fuel cells may be stacked in at least one of a vertical direction or a horizontal direction. The unit fuel cell may be a polymer electrolyte membrane fuel cell (or a proton exchange membrane fuel cell) (PEM FC), which has been studied most extensively as a power source for driving fuel cell vehicles. However, the embodiments are not limited to any specific form, configuration, or appearance of the unit fuel cell.

The unit fuel cell included in the fuel cell 110 may include end plates (pressing plates or compression plates) (not shown), current collectors (not shown), and a cell stack 112.

The cell stack 112 may include, for example, a plurality of unit cells stacked in the horizontal direction. Tens to hundreds of unit cells, for example, 100 to 400 unit cells, may be stacked to form the cell stack 112. The number of unit fuel cells included in the fuel cell 110 and the number of unit cells included in the cell stack 112 of the unit fuel cell may be determined based on the intensity of power to be supplied from the fuel cell 110 to the load 120.

The load 120 may be a component that requires power in the fuel cell vehicle 100. The load 120 may be connected to the cell stack 112 and the battery 130 and may receive power from the cell stack 112 or the battery 130. The load 120 may include an inverter (not shown) and a motor (not shown), for example. The inverter may convert DC voltage received from the multiphase converter 140 into AC voltage in accordance with the operational state of the fuel cell vehicle 100, and may output the AC voltage to the motor. The motor may operate in response to the AC voltage output from the inverter. For example, the motor may rotate in response to the AC voltage for the motor received from the inverter, thereby performing the function of driving the fuel cell vehicle 100. For example, the motor may be a three-phase alternating current (AC) rotating device that includes a rotor in which permanent magnets are embedded. However, the embodiments are not limited to any specific form of the inverter or the motor.

In addition, although not shown in the drawings, the fuel cell vehicle 100 may further include a peripheral auxiliary device (balance-of-plant (BOP)) and high-voltage components.

The end plates may be disposed at respective ends of the cell stack 112 and may support and fix the plurality of unit cells. For example, a first end plate may be disposed at one of the two opposite ends of the cell stack 112 and a second end plate may be disposed at the other of the two opposite ends of the cell stack 112.

In addition, the fuel cell 110 may further include a clamping member (not shown). The clamping member may comprise a bar shape, a long bolt shape, a belt shape, or a rigid rope shape to clamp the plurality of unit cells. For example, in each unit fuel cell, the clamping member may serve to clamp the plurality of unit cells in the horizontal direction together with the end plates.

The multiphase converter 140 may boost the stack voltage generated by the cell stack 112 of the fuel cell 110, and may output the boosted voltage to the load 120 or the battery 130. For example, the multiphase converter 140 may include a high-voltage boost DC/DC converter (or a fuel cell DC/DC converter (FDC)).

Generally, the FDC may perform the operation of matching the stack voltage generated by the fuel cell 110 with the voltage stored in the battery 130. The multiphase converter 140 may thus adjust the voltage range between the cell stack 112 and the battery 130. For example, while the level of the stack voltage is about 100 V to about 200 V, the voltage level of the battery 130 is about 600 V. Thus, the FDC may operate as a type of boost converter that steps up the stack voltage to 600 V.

The battery 130 stores the boosted voltage output from the multiphase converter 140.

As described in more detail below, the main controller 170 may serve to control the operation of the multiphase converter 140.

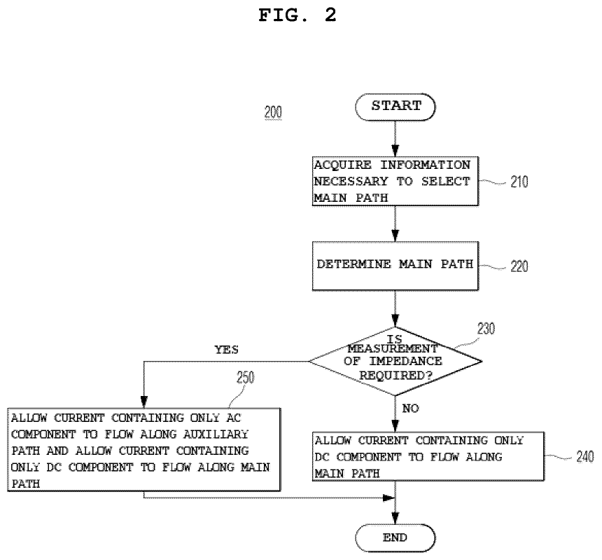

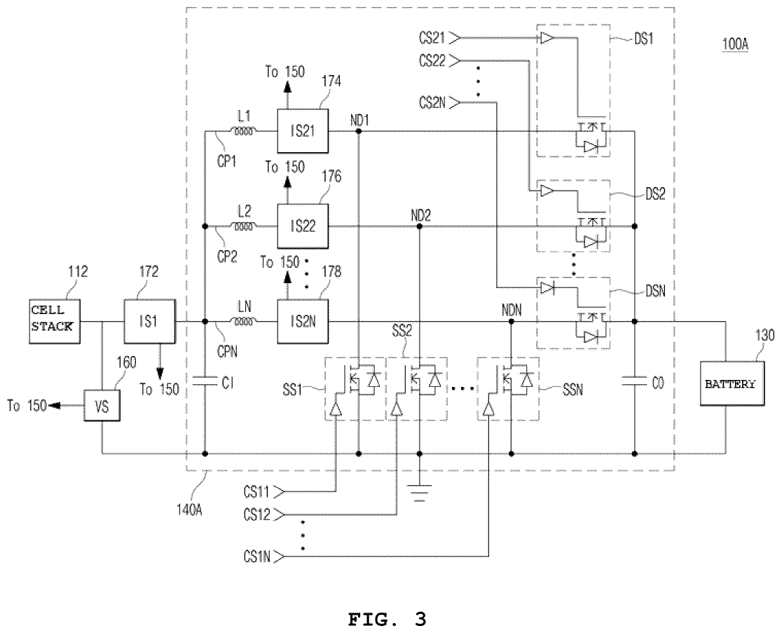

FIG. 2 is a flowchart for explaining a method 200 of controlling the fuel cell vehicle 100 according to an embodiment. FIG. 3 is a circuit diagram of an embodiment 100A of the fuel cell vehicle 100 shown in FIG. 1.

Hereinafter, the method 200 shown in FIG. 2 is described as being performed by the fuel cell vehicles 100 and 100A shown in FIGS. 1 and 3, and the fuel cell vehicles 100 and 100A shown in FIGS. 1 and 3 are described as performing the method 200 shown in FIG. 2. However, the present disclosure is not limited thereto. For example, the method 200 shown in FIG. 2 may also be performed by a fuel cell vehicle configured differently from the fuel cell vehicles 100 and 100A shown in FIGS. 1 and 3.

The fuel cell vehicle 100A shown in FIG. 3 may include the cell stack 112, a multiphase converter 140A, and the battery 130. In addition, the fuel cell vehicle 100A may further include the voltage sensor (VS) 160 and a current sensor. The current sensor may include a first current sensor (IS1) 172 and 2-1^{st}-2-N^{th} current sensors (IS21, IS22, . . . , and IS2N) 174, 176, . . . , and 178. Unlike the configuration shown in FIG. 3, the 2-1^{st}-2-N^{th} current sensors (IS21, IS22, . . . , and IS2N) 174, 176, . . . , and 178 may not be components of the multiphase converter 140A, in some embodiments.

The cell stack 112, the multiphase converter 140A, and the battery 130 correspond to the cell stack 112, the multiphase converter 140, and the battery 130 shown in FIG. 1, respectively. Illustration of the load 120, the main controller 150, and the temperature sensor TS shown in FIG. 1 is omitted in FIG. 3.

Before explaining the method 200 shown in FIG. 2, an embodiment 140A of the multiphase converter 140 shown in FIG. 1 is described with reference to FIG. 3.

The multiphase converter 140A shown in FIG. 3 may include first-N^{th} current paths connected to the cell stack 112, where N is a positive integer of 2 or greater. The first-Nth current paths may be connected in parallel to each other. One current path may correspond to one phase. Because a plurality of current paths is provided, the converter including the same is referred to as a “multiphase converter”.

The multiphase converter 140A shown in FIG. 3 may include an input capacitor CI, an output capacitor CO, first-N^{th} inductors L1-LN, first-N^{th} diode switches DS1-DSN, and first-N^{th} semiconductor switches SS1-SSN.

The input capacitor CI is connected between an output terminal of the cell stack 112 and an input terminal of the multiphase converter 140A. The input capacitor C1 may thus be connected between a positive output terminal PO1 of the cell stack 112 and a negative output terminal NO1 of the cell stack 112.

Each of the first-N^{th} inductors L1-LN has an end connected to a node between the positive output terminal PO1 of the cell stack 112 and the input capacitor CI and has another end connected to a corresponding one of the first to N^{th} diode switches DS1 to DSN. For example, the n^{th} inductor Ln has an end connected to the positive output terminal PO1 of the cell stack 112 and another end connected to the n^{th} diode switch DSn, where 1≤n≤N.

Further, the first-N^{th} inductors L1-LN are connected in parallel to each other.

Because each inductor forms one current path, the multiphase converter 140A shown in FIG. 3 has N current paths CP1, CP2, . . . , and CPN. The first inductor L1 forms a first current path CP1, the second inductor L2 forms a second current path CP2, and the N^{th} inductor LN forms an N^{th} current path CPN.

Among the first-N^{th} current paths CP1-CPN, a current path used to adjust a voltage range is referred to as a “main path”. Among the first-N^{th} current paths CP1-CPN, a current path other than the main path is referred to as an “auxiliary path”.

In addition, each of the first-N^{th} diode switches DS1-DSN may be connected between the other end of a corresponding one of the first-N^{th} inductors L1-LN and the battery 130. Each of the first-N^{th} diode switches DS1-DSN may be implemented in the form of a type of half bridge.

For example, each (DSn) of the first-N^{th} diode switches DS1-DSN may be switched on (or turned on) or switched off (or turned off) in response to a 2-n^{th} switching control signal CS2n, and may be connected between the other end of the n^{th} inductor Ln and the battery 130. The n^{th} diode switch DSn may have a gate connected to the 2-n^{th} switching control signal CS2n, a drain connected to the battery 130, and a source connected to the n^{th} inductor Ln.

The first-N^{th} semiconductor switches SS1-SSN may be connected between nodes ND1-NDN, between the first-N^{th} inductors L1-LN and the first-N^{th} diode switches DS1-DSN, and a reference potential. The reference potential may be the negative output terminal NO1 of the cell stack 112. The n^{th} semiconductor switch SSn may be connected between a node NDn, between the n^{th} inductor Ln and the n^{th} diode switch DSn, and the reference potential.

For example, each (SSn) of the first-N^{th} semiconductor switches SS1-SSN may be switched on (or turned on) or switched off (or turned off) in response to a 1-n^{th} switching control signal CS1n, and may be connected between the other end of the n^{th} inductor Ln and the negative output terminal NO1 of the cell stack 110. The n^{th} semiconductor switch SSn may have a gate connected to the 1-n^{th} switching control signal CS1n, a drain connected to the other end of the n^{th} inductor Ln, and a source connected to the negative output terminal NO1.

Each of the first-N^{th} diode switches DS1-DSN and the first-N^{th} semiconductor switches SS1-SSN may be implemented as an insulated gate bipolar transistor (IGBT) or a field effect transistor (FET). For example, each of the first to N^{th} diode switches DS1-DSN and the first-N^{th} semiconductor switches SS1-SSN may be implemented as a transistor, as shown in FIG. 3.

The output capacitor CO may be connected between the battery 130 and the reference potential (e.g., the negative output terminal NO1 of the cell stack 112).

Electrochemical impedance spectroscopy (EIS) may be applied to the battery 130 and the fuel cell 110. EIS is a technology that measures the impedance of the fuel cell 110, providing real-time information about the operation and performance of the fuel cell 110 using the measured impedance. This allows the fuel cell 110 to operate under optimal driving conditions, contributing to improved reliability and extended lifespan of the fuel cell 110. In the fuel cell vehicle, the impedance of the cell stack 112 of the fuel cell 110 may be used to determine the wet state of the cell stack 112, and humidification control suitable for a result of the determination may be performed, thereby improving the durability of the fuel cell 110.

The main controller 150 shown in FIG. 1 may control the multiphase converter 140 or 140A so that the direct current flowing along the main path contains only a direct-current (DC) component and the alternating current flowing along the auxiliary path contains only an alternating-current (AC) component.

When intending to measure the impedance of the cell stack 112, the main controller 150 may control the multiphase converter 140 or 140A so that the alternating current flows along the auxiliary path rather than the main path.

The main controller 150 may control switching operations of the first-N^{th} diode switches DS1-DSN and the first-N^{th} semiconductor switches SS1-SSN using a direct-current command value DCM and an alternating-current command value ACM provided from an upper-level controller (not shown) through the input terminal IN and results of sensing by the 2-1^{st}-2-N^{th} current sensors (IS21, IS22, . . . , and IS2N) 174, 176, . . . , and 178.

In an embodiment, the alternating-current command value ACM may include information such as multiple harmonics (or periods) and amplitude of the alternating current applied to the cell stack 112 to measure the impedance of the fuel cell 110.

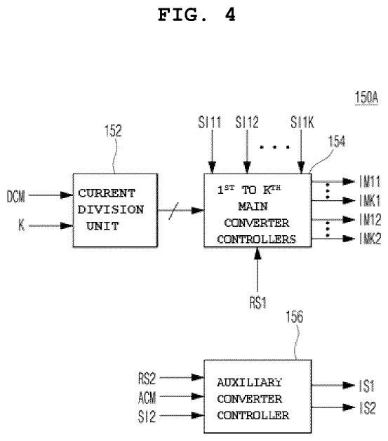

FIG. 4 is a block diagram of a main controller 150A, according to an embodiment. The main controller 150A corresponds to the main controller 150 shown in FIG. 1, in an embodiment.

The main controller 150A shown in FIG. 4 may include a current division unit 152, first to K^{th} main converter controllers 154, and an auxiliary converter controller 156.

The current division unit 152 may divide (e.g., equally divide) the direct-current command value DCM by the number K of main paths.

Using the divided (e.g., equally divided) direct-current command value DCM/K, current values SI11, SI12, . . . , and SI1K sensed from the main paths by some of the 2-1^{st}-2-N^{th} current sensors (IS21, IS22, . . . , and IS2N) 174, 176, . . . , and 178, and a first reference signal RS1, the first-K^{th} main converter controllers 154 serve to switch the first-K^{th} (1≤K<N) diode switches and the first-K^{th} semiconductor switches connected to the main paths among the first-N^{th} diode switches DS1, DS2, . . . , and DSN and the first-N^{th} semiconductor switches SS1, SS2, . . . , and SSN.

Using the alternating-current command value ACM, a current value SI2 sensed from the auxiliary path by one of the first-N^{th} current sensors, and a second reference signal, the auxiliary converter controller 156 serves to switch an auxiliary diode switch and an auxiliary semiconductor switch connected to the auxiliary path among the first-N^{th} diode switches DS1, DS2, . . . , and DSN and the first-N^{th} semiconductor switches SS1, SS2, . . . , and SSN.

FIG. 5 is a block diagram of main converter controllers 154A, according to an embodiment. The main converter controllers 154A may correspond to the first-K^{th} main converter controllers 154 shown in FIG. 4, in an embodiment.

The main converter controllers 154A include first-K^{th} main converter controllers 310, 320, . . . , and 330. Among the first-K^{th} main converter controllers 310, 320, . . . , and 330 shown in FIG. 5, the first main converter controller 310 may include a first subtractor 312, a first proportional integrator (PI1) 314, a first limiter (LM1) 316, a first comparator 318, and a first retarder (DL1) 319.

The first subtractor 312 may subtract a value SI11 obtained by sensing the current flowing along a first path among the main paths from the divided (e.g., equally divided) direct-current command value DCM/K, and may output a result of the subtraction to the first proportional integrator (PD1) 314.

The first proportional integrator (PI1) 314 proportionally integrates the output from the first subtractor 312, and outputs a result of the proportional integration.

The first limiter (LM1) 316 limits the level of the output from the first proportional integrator (PI1) 314, and outputs a result of the limiting. The first limiter (LM1) 316 may perform not only the function of limiting the level but also the function of eliminating disturbances.

The first comparator 318 compares the output from the first limiter (LM1) 316 with the first reference signal RS1, and outputs a result of the comparison as a 1-1^{st} main switching control signal IM11.

In this case, the first retarder (DL1) 319 may retard the 1-1^{st} main switching control signal IM11 output from the first comparator 318, and may output a result of the retardation as a 1-2^{nd} main switching control signal IM12.

The first retarder (DL1) 319 retards the 1-1^{st} main switching control signal IM11 to generate a 1-2^{nd} main switching control signal IM12 so that the 1-1^{st} main switching control signal IM11 and the 1-2^{nd} main switching control signal IM12 have opposite logic levels. The duty ratios of the 1-1^{st} main switching control signal IM11 and the 1-2^{nd} main switching control signal IM12 are calculated as shown in Equation 1 below.

$$D 1 = \frac{T 1}{T P 1} \qquad [ Equation 1 ]$$

$$D 2 = \frac{T 2}{T P 1}$$

In Equation 1, D1 represents the duty ratio of the 1-1^{st} main switching control signal IM11, D2 represents the duty ratio of the 1-2^{nd} main switching control signal IM12, TP1 represents the cycle of each of the 1-1^{st} main switching control signal IM11 and the 1-2^{nd} main switching control signal IM12, T1 represents a time period during which the 1-1^{st} main switching control signal IM11 maintains a “high” logic level, and T2 represents a time period during which the 1-2^{nd} main switching control signal IM12 maintains a “high” logic level. T1 and T2 have a relationship shown in Equation 2 below.

$$TP 1 = T 1 + T 2 \qquad [ Equation 2 ]$$

Each of the second to K^{th} main converter controllers 320, . . . , and 330 has the same configuration as the first main converter controller 310, in an embodiment. Therefore, a duplicate description thereof has been omitted. The k^{th} (1≤k<K) main converter controller MCCk may output a k−1^{st} main switching control signal IMk1 and a k−2^{nd} main switching control signal IMk2.

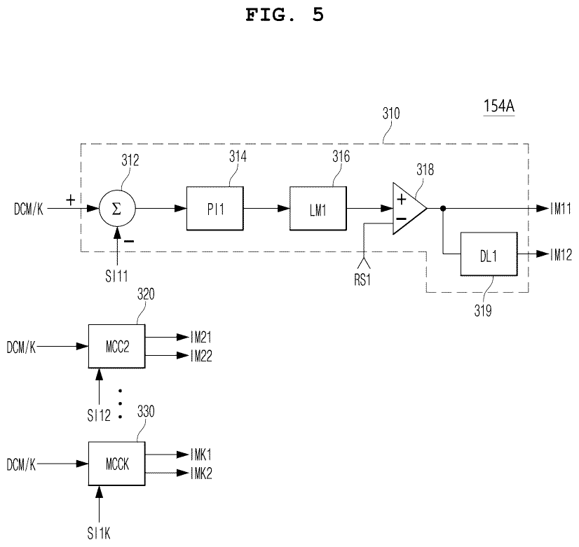

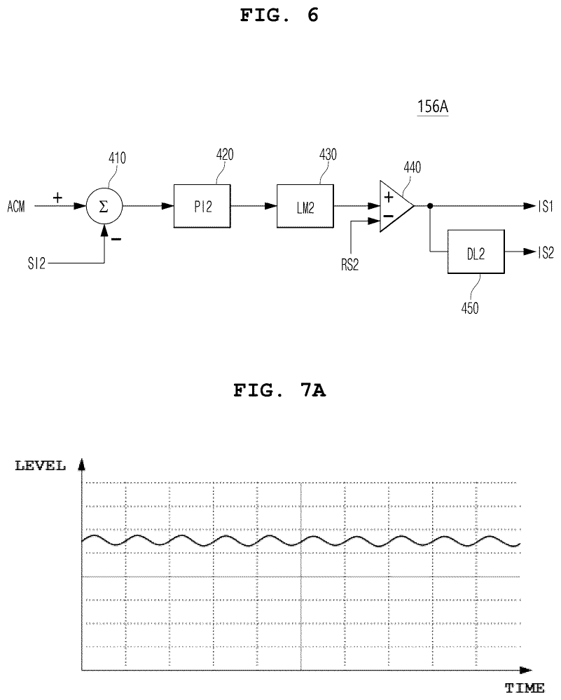

FIG. 6 is a block diagram of an auxiliary converter controller 156A, according to an embodiment. The auxiliary converter controller 156A corresponds to the auxiliary converter controller 156 shown in FIG. 4, in an embodiment.

The auxiliary converter controller 156A shown in FIG. 6 may include a second subtractor 410, a second proportional integrator (PI2) 420, a second limiter (LM2) 430, a second comparator 440, and a second retarder (DL2) 450.

The second subtractor 410 may subtract a value SI2 obtained by sensing the current flowing along the auxiliary path from the alternating-current command value ACM, and may output a result of the subtraction to the second proportional integrator (PD2) 420.

The second proportional integrator (PI2) 420 proportionally integrates the output from the second subtractor 410, and outputs a result of the proportional integration.

The second limiter (LM2) 430 limits the level of the output from the second proportional integrator (PI2) 420, and outputs a result of the limiting.

The second comparator 440 compares the output from the second limiter (LM2) 430 with the second reference signal RS2, and outputs a result of the comparison as a first auxiliary switching control signal IS11.

In this case, the second retarder (DL2) 450 may retard the first auxiliary switching control signal IS1 output from the second comparator 440, and may output a result of the retardation as a second auxiliary switching control signal IS2.

The second retarder (DL2) 450 retards the first auxiliary switching control signal IS1 to generate a second auxiliary switching control signal IS2 so that the first auxiliary switching control signal IS1 and the second auxiliary switching control signal IS2 have opposite logic levels. The duty ratios of the first auxiliary switching control signal IS1 and the second auxiliary switching control signal IS2 are calculated as shown in Equation 3 below.

$$D 3 = \frac{T 3}{TP 2} \qquad [ Equation 3 ]$$

$$D 4 = \frac{T 4}{T P 2}$$

In Equation 3, D3 represents the duty ratio of the first auxiliary switching control signal IS1, D4 represents the duty ratio of the second auxiliary switching control signal IS2, TP2 represents the cycle of each of the first auxiliary switching control signal IS1 and the second auxiliary switching control signal IS2, T3 represents a time period during which the first auxiliary switching control signal IS1 maintains a “high” logic level, and T4 represents a time period during which the second auxiliary switching control signal IS2 maintains a “high” logic level. T3 and T4 have a relationship shown in Equation 4 below.

$$TP 2 = T 3 + T 4 \qquad [ Equation 4 ]$$

Each of the 1-1^{st} to K-1^{st} main switching control signals IM11 to IMK1, the 1-2^{nd} to K-2^{nd} main switching control signals IM12 to IMK2, and the first and second auxiliary switching control signals IS1 and IS2 shown in FIGS. 5 and 6 may be a pulse width modulation (PWM) signal.

For example, if the first-N−1^{th} current paths are determined to be the main paths, if the N^{th} current path is determined to be the auxiliary path, and if K=N−1, the 1-1^{st}-K-1^{st} main switching control signals IM11-IMK1 correspond to the 1-1^{st}-1-(N−1)^{th} switching control signals CS11 to CS1(N−1) shown in FIG. 3, the 1-2^{nd}-K-2^{nd} main switching control signals IM12-IMK2 correspond to the 2-1^{st}-2-(N−1)^{th} switching control signals CS21 to CS2(N−1) shown in FIG. 3, the first auxiliary switching control signal IS1 corresponds to the 1-N^{th} switching control signal CS1N, and the second auxiliary switching control signal IS2 corresponds to the 2-N^{th} switching control signal CS2N.

In the configuration shown in FIGS. 5 and 6, the first to K^{th} main converter controllers 154A and the first and second auxiliary converter controllers 156A are implemented in a current control manner. However, the present disclosure is not limited thereto. For example, the first-K^{th} main converter controllers 154A and the first and second auxiliary converter controllers 156A may be implemented in a combination of a voltage control manner and a current control manner.

The voltage sensor 160 may be disposed at the input terminal of the multiphase converter 140A. The voltage sensor 160 may sense the voltage of the cell stack 112, i.e., a voltage input to the multiphase converter 140A, and may output the sensed voltage to the main controller 150. To this end, the voltage sensor 160 may be connected in parallel to the input capacitor CI.

The 2-1^{st}-2-N^{th} current sensors IS21, IS22, . . . , and IS2N may sense currents flowing along the first to N^{th} current paths CP1, CP2, . . . , and CPN, and may output the sensed currents to the main controller 150.

According to the embodiment, the main controller 150 or 150A may determine the number of main paths using the results of the sensing by the voltage sensor (VS) 160 and the 2-1^{st}-2-N^{th} current sensors (IS21, IS22, . . . , and IS2N) 174, 176, . . . , and 178.

The temperature sensor (TS) 180 may sense the temperature of the fuel cell 110, and may output the sensed temperature to the main controller 150.

According to another embodiment, the main controller 150 or 150A may further use the result of the sensing by the temperature sensor (TS) 180 to determine the number of main paths.

As described above, the current path other than the main paths, among the first-N^{th} current paths CP1-CPN, corresponds to the auxiliary path, in an embodiment. Therefore, upon receiving an impedance signal requesting measurement of the impedance of the cell stack 112 through the input terminal IN, the main controller 150 or 150A may determine one of the first-N^{th} current paths CP1-CPN to be the auxiliary path in response to the impedance signal.

Hereinafter, a method 200 of controlling the fuel cell vehicle according to an embodiment is described in more detail with reference to FIG. 2. The method 200 shown in FIG. 2 may be performed by the main controller 150 or 150A.

In a step or operation 210, the main controller 150 acquires information necessary to select a main path used for adjustment of a voltage range from among the first-N^{th} current paths CP1, CP2, . . . , and CPN.

For example, the information necessary to select the main path may include at least one of the voltage input to the multiphase converter 140, the value of the current flowing along each of the first to N^{th} current paths CP1 to CPN, or the temperature of the fuel cell 110. Therefore, the main controller 150 may acquire information necessary to select the main path from the voltage sensor (VC) 160, the current sensor (IS) 170, and the temperature sensor (TS) 180.

In a step or operation 220, the main path is determined among the first to N^{th} current paths CP1, CP2, . . . , and CPN using the acquired information.

If the value obtained by sensing the input current (or input power) is small, the number of main paths may be determined to be one. As the magnitude of the sensed value gradually increases, the number of main paths may be increased.

Considering the current sensed by the current sensor (IS) 170 and the temperature sensed by the temperature sensor (TS) 180, for example, if the number of main paths is determined to be two when the input current is 100 A at a room temperature of about 60°, the number of main paths may be determined to be two when the input current is 80 A at a high temperature of about 80°.

In a step or operation 230, whether measurement of the impedance of the cell stack 112 is required is determined. For example, the main controller 150 may receive a request for measurement of the impedance from the upper-level controller through the input terminal IN.

If measurement of the impedance is not required, a current containing only a direct-current component is caused to flow along the main path in a step or operation 240.

On the other hand, if measurement of the impedance is required, a sine wave needs to be applied to the fuel cell 110. For example, if measurement of the impedance is required, a current containing only an alternating-current component is caused to flow along the auxiliary path rather than the main path among the first to N^{th} current paths CP1 to CPN, and a current containing only a direct-current component is caused to flow along the main path in a step or operation 250.

Hereinafter, in order to aid in understanding the embodiment, it is assumed that N is three (N=3), K is two (K=2), the first and second current paths CP1 and CP2 among the first to third current paths CP1, CP2, and CP3 are the main paths, and the third current path CP3 among the first to third current paths CP1, CP2, and CP3 is the auxiliary path.

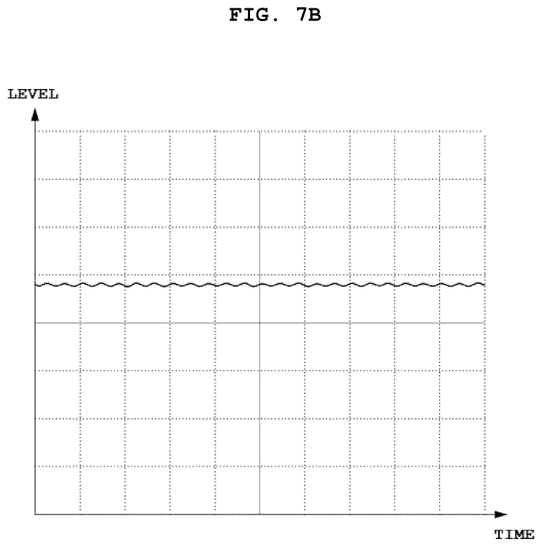

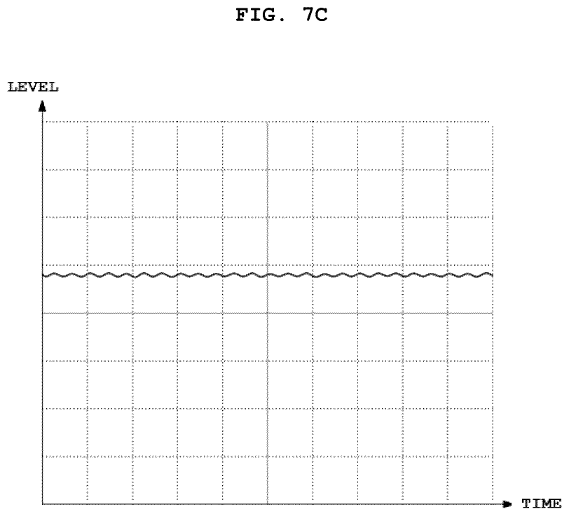

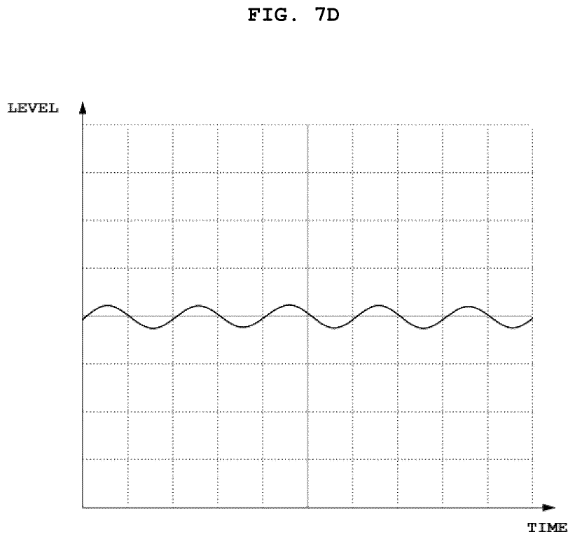

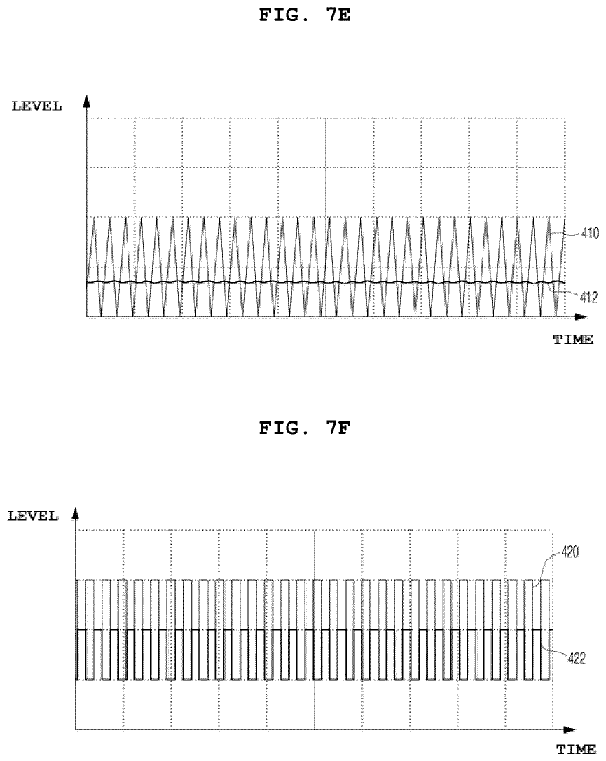

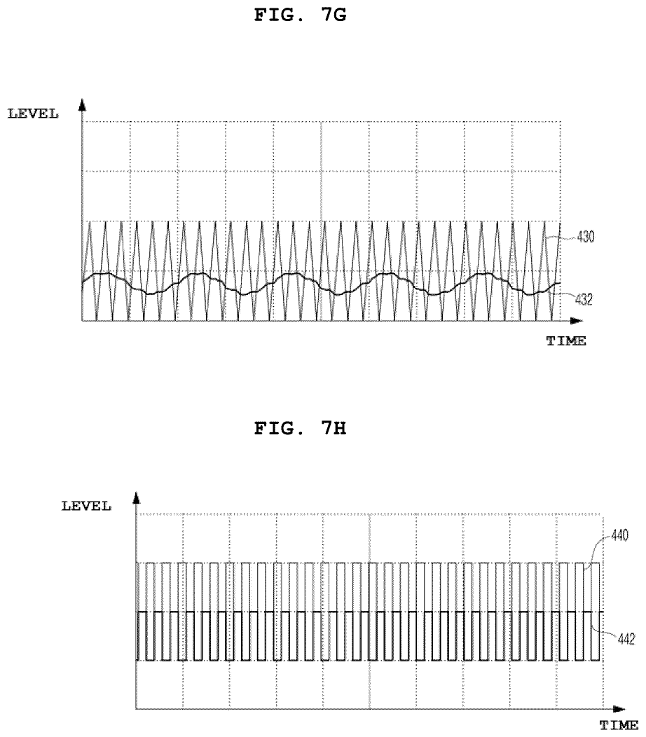

FIGS. 7A to 7H are waveform diagrams of the respective terminals in the circuits shown in FIGS. 3, 5, and 6, in which the horizontal axis represents time, and the vertical axis represents level.

FIG. 7A is a waveform diagram of a current sensed by the first current sensor (IS1) 172. FIG. 7B is a waveform diagram of a current sensed by the 2-1^{st} current sensor (IS21) 174. FIG. 7C is a waveform diagram of a current sensed by the 2-2^{nd} current sensor (IS22) 176, FIG. 7D is a waveform diagram of a current sensed by the 2-3^{rd} current sensor (IS23) 178. FIG. 7E illustrates waveform diagrams of the first reference signal (RS1) 410 shown in FIG. 5 and a signal 412 output from the first limiter (LM1) 316. FIG. 7F illustrates waveform diagrams of the 1-1^{st} main switching control signal (IM11) 420 and the 1-2^{nd} main switching control signal (IM12) 422. FIG. 7G illustrates waveform diagrams of the second reference signal (RS2) 430 shown in FIG. 6 and a signal 432 output from the second limiter (LM2) 440, and FIG. 7H illustrates waveform diagrams of the first auxiliary switching control signal (IS1) 440 and the second auxiliary switching control signal (IS2) 442.

If measurement of the impedance is not required, the currents shown in FIGS. 7B and 7C, which contain only a direct-current component, flow along the first and second main paths CP1 and CP2 through the first and second inductors L1 and L2, respectively.

On the other hand, if measurement of the impedance is required, the currents shown in FIGS. 7B and 7C, which contain only a direct-current component, flow along the first and second main paths CP1 and CP2 through the first and second inductors L1 and L2, respectively, and at the same time, the current shown in FIG. 7D, which contains only an alternating-current component, flows along the auxiliary path CP3 through the third inductor L3.

The main controller 150 may measure the impedance using an alternating voltage M V and an alternating current M In, as shown in Equation 5 below.

$$Z = MV \times MIn \qquad [ Equation 5 ]$$

In Equation 5, Z represents the impedance, MV represents an alternating voltage measured by the voltage sensor (VS) 160 shown in FIG. 3, and MIn represents an alternating current measured by the current sensor disposed on the auxiliary path (e.g., current sensor (IS2N) 178 shown in FIG. 3).

In order to implement the above-described operation, the 1-1^{st} main switching control signal (IM11) 420 shown in FIG. 7F may be applied to the first and second semiconductor switches SS1 and SS2, and the 1-2^{nd} main switching control signal (IM12) 422 shown in FIG. 7F may be applied to the first diode switch DS1. In addition, the first auxiliary switching control signal (IS1) 440 shown in FIG. 7H may be applied to the third semiconductor switch SS3, and the second auxiliary switching control signal (IS2) 442 shown in FIG. 7H may be applied to the third diode switch DS3.

Hereinafter, a fuel cell apparatus according to a comparative example and the fuel cell vehicle according to embodiments of the present disclosure are compared with each other.

In the case of the comparative example, a separate alternating current (AC) application device is manufactured and used in order to inject an AC waveform into a cell stack during EIS measurement. Accordingly, an additional circuit configuration is required, which leads to increase in the volume and price of a fuel cell vehicle.

The comparative example includes a method of generating injected current of a fuel cell stack performed in an apparatus for generating injected current of a fuel cell stack. In detail, according to the comparative example, the method includes extracting a first frequency current and a second frequency current by passing alternating currents of different frequencies through a plurality of filters, generating a summed frequency current by summing the first frequency current and the second frequency current, and applying the summed frequency current to the fuel cell stack. In this way, the summed current obtained by summing the alternating current for calculating the total harmonic distortion (THD) and the alternating current for calculating the impedance is applied to the fuel cell stack.

However, in the case of the comparative example, in order to generate alternating currents of different frequencies, a plurality of AC generator is provided corresponding to the plurality of frequencies, which makes the configuration of the system complicated and causes increase in manufacturing costs.

During phase shedding of a multiphase converter, there is at least one phase that does not operate when operating the multiphase converter with an optimal constant in order to improve efficiency under heavy-load and light-load conditions. According to embodiments of the present disclosure, a command value of an AC waveform is provided to a phase that does not operate in the multiphase converter, thereby generating an input current containing a desired AC component.

In this way, according to embodiments of the present disclosure, an AC waveform for measurement of impedance may be applied to a phase that is not used among the multiple phases through phase shedding in order to improve the efficiency of the multiphase converter 140. Therefore, it is not necessary to add a separate circuit such as an AC generator for measurement of impedance. As a result, the circuit configuration of the fuel cell vehicle may be simplified, and the manufacturing costs and the volume thereof may be reduced.

In addition, in EIS, if a direct-current component is added to the alternating current applied to the cell stack 112, a current root-mean-square (RMS) value increases, and the temperature of a power semiconductor and passive components in the FDC increases, which may adversely affect the durability of the FDC. Further, when the impedance of the fuel cell is measured, only AC control is required for a relatively short time period, and non-pulsed operation is performed in a state in which multiple frequencies are mixed, whereby not only the FDC but also peripheral devices of the stack (balance-of-plant) should be designed taking into consideration corresponding conditions, leading to increase in costs of a fuel cell system. In contrast, according to the embodiment, because an alternating current flowing along the auxiliary path contains no direct-current component, it is possible to overcome the aforementioned problem of cost increase.

As is apparent from the above description, according to a fuel cell vehicle and a method of controlling the same according to embodiments of the present disclosure, an AC waveform for measurement of impedance may be applied to a phase that is not used among multiple phases through phase shedding. Accordingly, the circuit configuration of the fuel cell vehicle may be simplified, and the manufacturing costs and the volume thereof may be reduced.

However, the effects achievable through the present disclosure are not limited to the above-mentioned effects. Other effects not mentioned herein should be more clearly understood by those having ordinary skill in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to illustrative embodiments thereof, these embodiments are only proposed for illustrative purposes, and do not restrict the present disclosure. It should be apparent to those having ordinary skill in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A fuel cell vehicle, comprising:
a battery;
a cell stack configured to supply a stack voltage;
a multiphase converter configured to adjust a voltage range between the cell stack and the battery, the multiphase converter including a plurality of current paths connected to the cell stack; and
a main controller configured to, for measurement of impedance of the cell stack, control the multiphase converter to allow an alternating current to flow along an auxiliary path rather than a main path used to adjust the voltage range among the plurality of current paths.

2. The fuel cell vehicle according to claim 1, wherein the main controller is configured to control the multiphase converter so that a direct current flowing along the main path contains only a direct-current component and the alternating current flowing along the auxiliary path contains only an alternating-current component.

3. The fuel cell vehicle according to claim 1, wherein the plurality of current paths includes first-N^{th} current paths, and wherein the fuel cell vehicle further comprises:
a voltage sensor configured to sense a voltage input to the multiphase converter; and
first-N^{th} current sensors configured to sense currents flowing along the first-N^{th} current paths,
wherein the main controller is configured to determine a number of main paths using results of sensing by the voltage sensor and the first-N^{th} current sensors, and
where N is a positive integer of 2 or greater.

4. The fuel cell vehicle according to claim 3, further comprising a temperature sensor configured to sense a temperature of the cell stack,
wherein the main controller is configured to determine the number of main paths using a result of sensing by the temperature sensor.

5. The fuel cell vehicle according to claim 1, wherein the main controller is configured to determine one of the plurality of current paths to be the auxiliary path in response to an impedance signal requesting measurement of the impedance of the cell stack.

6. The fuel cell vehicle according to claim 3, wherein the multiphase converter includes:
an input capacitor connected to an output terminal of the cell stack;
first-N^{th} inductors connected in parallel to each other, each of the first-N^{th} inductors including an end connected between the output terminal of the cell stack and the input capacitor;
first-N^{th} diode switches, each being connected between another end of a corresponding one of the first-N^{th} inductors and the battery;
first-N^{th} semiconductor switches connected between nodes, between the first-N^{th} inductors and the first-N^{th} diode switches, and a reference potential; and
an output capacitor connected between the battery and the reference potential.

7. The fuel cell vehicle according to claim 6, wherein the main controller is configured to control switching operations of the first-N^{th} diode switches and the first-N^{th} semiconductor switches using a direct-current command value, an alternating-current command value, and results of sensing by the first-N^{th} current sensors.

8. The fuel cell vehicle according to claim 7, wherein the main controller includes:
a current division unit configured to divide the direct-current command value by the number of main paths;
first-K^{th} main converter controllers configured to switch first-K^{th} diode switches and first-K^{th} semiconductor switches connected to the main paths among the first-N^{th} diode switches and the first-N^{th} semiconductor switches using the divided direct-current command value and current values sensed from the main paths by some of the first-N^{th} current sensors, wherein 1≤K<N; and
an auxiliary converter controller configured to switch an auxiliary diode switch and an auxiliary semiconductor switch connected to the auxiliary path among the first-N^{th} diode switches and the first-N^{th} semiconductor switches using the alternating-current command value and a current value sensed from the auxiliary path by one of the first-N^{th} current sensors.

9. The fuel cell vehicle according to claim 8, wherein a k^{th} main converter controller includes:
a first subtractor configured to subtract a value obtained by sensing a current flowing along a k^{th} path among the main paths from the divided direct-current command value;
a first proportional integrator configured to proportionally integrate an output from the first subtractor and output a result of proportional integration;
a first limiter configured to limit a level of an output from the first proportional integrator;
a first comparator configured to compare an output from the first limiter with a first reference signal and output a result of comparison as a k^{th} main switching control signal; and
a first retarder configured to retard the k^{th} main switching control signal and output a result of retardation as a k′^{th} main switching control signal,
wherein a k^{th} semiconductor switch is switched in response to the k^{th} main switching control signal, and
wherein a k^{th} diode switch is switched in response to the k′^{th} main switching control signal,
wherein 1≤k≤K.

10. The fuel cell vehicle according to claim 8, wherein the auxiliary converter controller includes:
a second subtractor configured to subtract a value obtained by sensing a current flowing along the auxiliary path from the alternating-current command value;
a second proportional integrator configured to proportionally integrate an output from the second subtractor and output a result of proportional integration;
a second limiter configured to limit a level of an output from the second proportional integrator;
a second comparator configured to compare an output from the second limiter with a second reference signal and output a result of comparison as a first auxiliary switching control signal; and
a second retarder configured to retard the first auxiliary switching control signal and output a result of retardation as a second auxiliary switching control signal,
wherein the auxiliary semiconductor switch is switched in response to the first auxiliary switching control signal, and
wherein the auxiliary diode switch is switched in response to the second auxiliary switching control signal.

11. The fuel cell vehicle according to claim 8, wherein the current division unit is configured to equally divide the direct-current command value by the number of main paths.

12. The fuel cell vehicle according to claim 1, wherein current paths among the plurality of current paths of the multiphase converter are connected in parallel to each other.

13. A method of controlling a fuel cell vehicle comprising a battery, a cell stack configured to supply a stack voltage, and a multiphase converter configured to adjust a voltage range between the cell stack and the battery, the multiphase converter including a plurality of current paths connected to the cell stack, the method comprising:
acquiring information for selecting a main path, from among the plurality of current paths, used to adjust the voltage range;
determining the main path among the plurality of current paths using the acquired information; and
allowing a current containing only an alternating-current component to flow along an auxiliary path rather than the main path among the plurality of current paths and allowing a current containing only a direct-current component to flow along the main path, for measurement of impedance of the cell stack.

14. The method according to claim 13, wherein the information for selecting the main path includes at least one of:
a voltage input to the multiphase converter;
a value of a current flowing along each of the plurality of current paths; or
a temperature of the cell stack.

15. The method according to claim 13, wherein current paths among the plurality of current paths of the multiphase converter are connected in parallel to each other.
